(19) United States
(12) Patent Application Publication
(10) Pub. No.: US 2016/0125453 A1
(43) Pub. Date: May 5, 2016

(54) ADVERTISEMENT VIEWABILITY DETERMINATION

(71) Applicant: Yahoo!, Inc., Sunnyvale, CA (US)

(72) Inventors: Ashish Shukla, Sunnyvale, CA (US); Richard Hansen, Alviso, CA (US); Sean Snider, La Jolla, CA (US); Jayadev Billa, San Jose, CA (US); John Logan, Sunnyvale, CA (US); Kieran Michael Boyle, Redwood City, CA (US)

(21) Appl. No.: 14/534,118

(22) Filed: Nov. 5, 2014

(51) Int. Cl. G06Q 30/02

(52) U.S. Cl. CPC G06Q 30/0246

(57) ABSTRACT

One or more systems and/or techniques for determining advertisement viewability are described herein. In an example where a webpage comprises a managed container within which an advertisement is populated, view percentage functionality associated with the managed container may be invoked to obtain a stream of viewable percentages of the managed container to determine a viewable percentage of the advertisement. In an example where the webpage comprises an unmanaged container in which the advertisement is populated, a grid may be generated and evaluated to determine a viewable percentage of the advertisement. When the viewable percentage of the advertisement is above a percentage threshold for a duration threshold a viewable impression beacon is generated for the managed container based upon the viewable percentage. The viewable impression beacon may be indicative of viewability of the advertisement (e.g., an amount of the advertisement that may be visible to a user).

### BACKGROUND

A website owner and/or operator may sell advertising space on a webpage to display advertisements. Such advertisements are often displayed on a client device alongside primary content. The primary content may be requested by a user on the client device (e.g., a gardening article of a gardening website). The website may sell the advertising space based upon a number of users to whom the advertisement is displayed (e.g., a number of impressions), a number of times that users engage with the advertisement, or a percentage of the advertisement that is viewable or visible to the user. Currently, websites tend to sell advertising space based upon the number impressions and/or user engagement, because there is no standard technique for determining the percentage of the advertisement that is viewable to a user when the user is employing various browsers and/or webpage elements.

### SUMMARY

In accordance with the present disclosure, a webpage may comprise an advertisement that is either not comprised within a container or is comprised within a managed container (e.g., based upon an implementation of a secondary domain between the webpage and an external source providing the advertisement). Responsive to the advertisement not being comprised within the container, the managed container may be generated to encompass the advertisement. A view percentage functionality, associated with the managed container, may be invoked to obtain a stream of viewable percentages of the managed container. The stream of viewable percentages comprise a first stream portion and a second stream portion.

A viewable percentage of the managed container may be determined by polling over a first duration at a first rate to obtain the first stream portion. Responsive to the viewable percentage of the managed container being over a first percentage threshold for the first duration, the polling may be altered from the first rate to a second rate for a second duration to generate the second stream portion. The second rate may be faster than the first rate. Responsive to the viewable percentage being above a percentage threshold for a duration threshold, a viewable impression beacon, which may comprise the viewable percentage, is generated for the managed container based upon the viewable percentage. The viewable impression beacon may be indicative of viewability of the advertisement. In an example, the viewable impression beacon may be sent to a database. An advertisement sale may be facilitated based upon the viewable impression beacon

In accordance with the present disclosure, the webpage may be determined to comprise an unmanaged container within which the advertisement is populated. The webpage may be determined to comprise the unmanaged container by determining that the advertisement is populated in an iframe. Responsive to determining that parent access to a document object model (DOM) is available, the DOM may be traversed to identify a container offset of the unmanaged container. The container offset may be identified by determining pixel coordinates of the unmanaged container that is viewable in a window displaying the webpage. The container offset may be compared to a window size of the webpage to determine the viewable percentage. The viewable impression beacon may be generated for the unmanaged container based upon the viewable percentage.

Responsive to determining that parent access to the DOM is not available, a grid may be generated over the unmanaged container. A number of browser animation plugins that are painted in the grid may be detected by counting a number of enterframes in the grid. A second viewable percentage of the unmanaged container may be determined by comparing the number of browser animation plugins that are painted in the unmanaged container to a total number of browser animation plugins in the unmanaged container. The viewable impression beacon may be generated for the unmanaged container based upon the second viewable percentage.

Responsive to determining that parent access to the DOM is not available and that an application program interface (API) configured to track a paint count is available, a grid of transparent containers may be created. Paint count information for the grid of transparent containers may be evaluated. Responsive to the paint count information indicating that the paint count has increased in a first transparent container, the first transparent container of the grid may be determined to have been painted. A third viewable percentage based upon a number of painted containers in relation to a total number of containers may be determined. The viewable impression beacon for the unmanaged container may be generated based upon the third viewable percentage.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of determining advertisement viewability.

FIG. 5 is a flow chart illustrating an example method of determining advertisement viewability.

FIG. 6A is a component block diagram illustrating an example system for determining advertisement viewability when an advertisement is populated in an unmanaged container and where parent access is available.

FIG. 6B is a component block diagram illustrating an example system for determining advertisement viewability when an advertisement is populated in an unmanaged container and where parent access is available.

FIG. 7A is a component block diagram illustrating an example system for determining advertisement viewability when an advertisement is populated in an unmanaged container and where parent access is not available.

FIG. 7B is a component block diagram illustrating an example system for determining advertisement viewability when an advertisement is populated in an unmanaged container and where parent access is not available.

FIG. 8A is a component block diagram illustrating an example system for determining advertisement viewability when an advertisement is populated in an unmanaged container and where parent access is not available and an application program interface (API) is available.

FIG. 8B is a component block diagram illustrating an example system for determining advertisement viewability when an advertisement is populated in an unmanaged container and where parent access is not available and an application program interface (API) is available.

FIG. 9 is an illustration of a scenario featuring an example non-transitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. COMPUTING SCENARIO

The following provides a discussion of some types of computing scenarios in which the disclosed subject matter may be utilized and/or implemented.

1.1. Networking

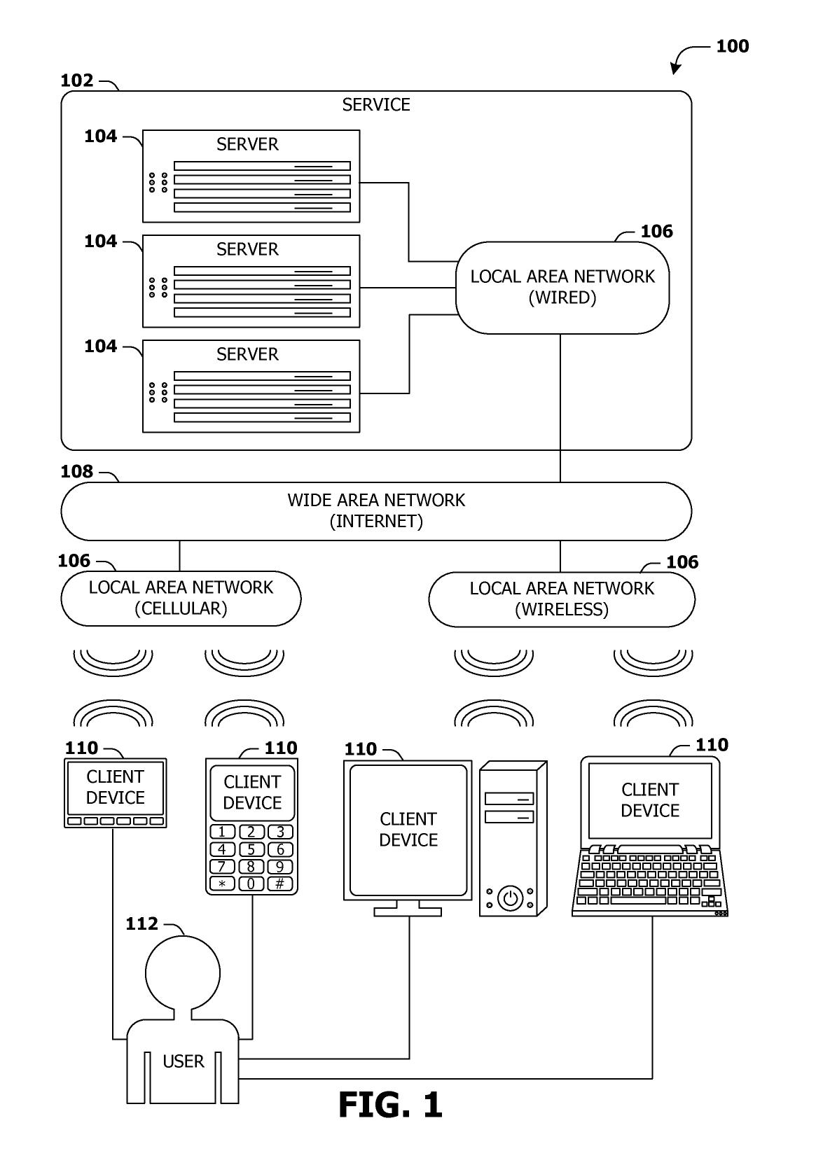

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

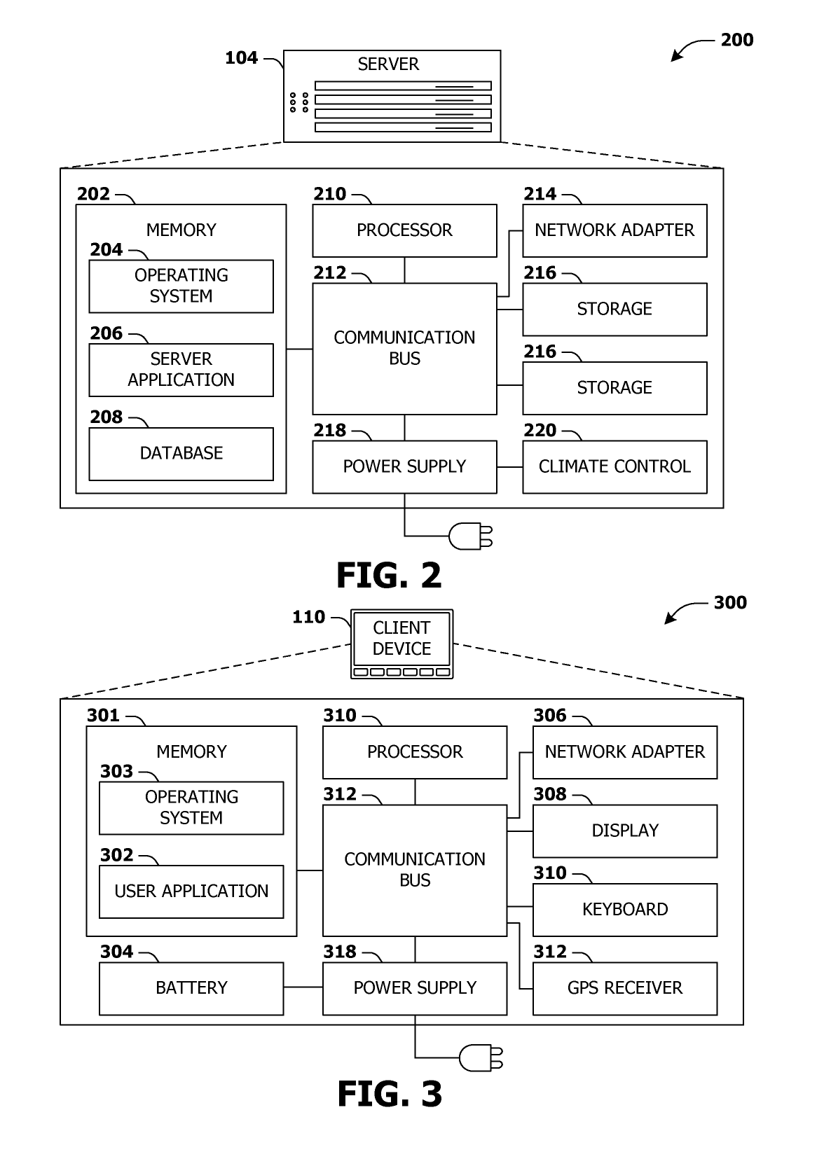

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. PRESENTED TECHNIQUES

One or more systems and/or techniques for determining advertisement viewability are provided herein. A user on a client device may view primary content on a webpage, where primary content may comprise content which the user intended to view (e.g., the main body of a gardening webpage containing a gardening article, a gardening blog, a gardening image, etc.). While viewing primary content, the user may view an advertisement (e.g., an advertisement that is adjacent or near to the primary content). Identification of viewability of an advertisement (e.g., whether the advertisement is currently visible and by how much to the user) may be difficult or impractical due to the advertisement being displayed through one of many potential browsers to the user and/or due the advertisement being comprised within one of many potential types of website elements (e.g., a managed container, an unmanaged container, no container, and/or other elements of a website)

Owner(s) and/or operator(s) of the webpage may sell advertising space on the webpage to an advertiser. The advertiser may prefer to pay for advertisements that are viewable to the user, rather than merely paying when the advertisement is present on the webpage, but not necessarily viewable to the user (e.g., the user may need to scroll down the webpage to bring the advertisement into view). Websites may prefer to be paid for advertisements that are viewable to the user, rather than being paid when the advertisement is engaged with by the user because various factors, such as the quality, appearance, content, and other factors beyond the control of the website, may impact on whether the advertisement is selected by the user. Thus, a low quality advertisement may be viewed by many users, but because the low quality advertisement is unappealing, it will not be selected by many users.

The ability to reliably, over a multitude of browsers and/or element types, determine a viewable percentage of the advertisement provides webpage owner(s) and/or operator(s) with an efficient manner with which to sell advertising space on the webpage. Further, advertisers may be more likely to purchase advertising space from the owner(s) and/or operator(s) of the webpage when they are able to pay based upon advertisement viewability.

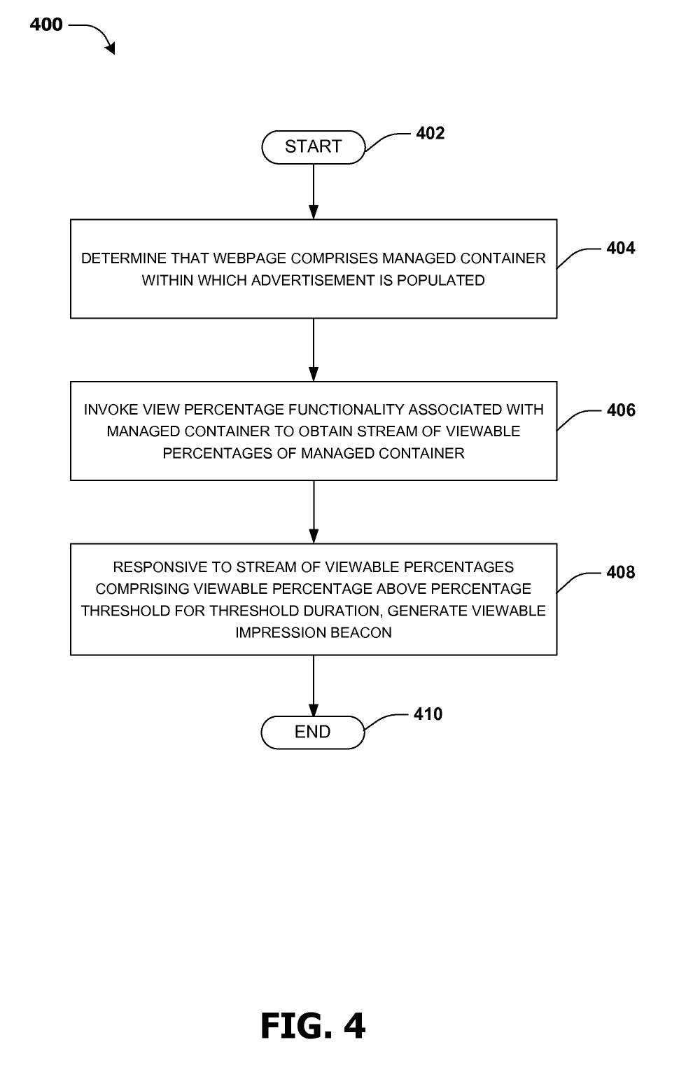

An embodiment for determining advertisement viewability is illustrated by method 400 of FIG. 4. A user may access a webpage comprising primary content (e.g., videogame reviews of a videogame webpage). The webpage may comprise additional content, such as an advertisement (e.g., adjacent or near to the primary content). At 402, the method 400 starts. At 404, the webpage may be determined as comprising a managed container within which the advertisement is populated. In an example, the managed container may comprise an iframe. The managed container may comprise a secondary domain (e.g., a domain that functions independently of the webpage) implemented between the webpage and an external source from which the advertisement is populated. In an example, the managed container may isolate external content from the external source. In an example, the managed container may enable improved rendering of rich media in the iframe.

While viewing the primary content, a variable viewable percentage of the advertisement may be viewable to the user (e.g., the user may scroll the advertisement into and/or out of view while navigating the webpage). At 406, a view percentage functionality associated with the managed container may be invoked to obtain a stream of viewable percentage of the managed container. In an example, the viewable percentage comprises a percentage of the managed container that is viewable to the user on the client device. In an example, the stream of viewable percentages comprises a series of determinations of the viewable percentage of the managed container over a duration threshold. In an example, the stream of viewable percentages comprises a first stream portion and a second stream portion.

The view percentage functionality may be invoked to determine the viewable percentage of the managed container by polling over a first duration at a first rate to obtain the first stream portion. In an example, the first rate may be between about 650 ms to about 850 ms or any other rate (e.g., a determination of the viewable percentage of the managed container may occur every 650 ms). In an example, the first rate may be selected such that the polling does not negatively impact performance (e.g., scroll performance, paint performance, and interaction performance, etc.), while still generating a relevant estimate of viewability. In an example, the first duration may be between about 1 s to about 5 s or any other duration during which the first percentage threshold to be met. In an example, the first percentage threshold may comprise a first specified percentage.

Responsive to the viewable percentage of the managed container being over the first percentage threshold for the first duration, the polling is altered from the first rate to a second rate for a second duration to generate the second stream portion. The second rate may be faster than the first rate. In an example, the second rate may be between about 50 ms to about 150 ms or any other rate (e.g., the determination of the viewable percentage of the managed container may occur every 100 ms). In an example, the second duration may be between about 0.5 s to about 1.5 s or any other duration. In an example, a second percentage threshold may be the same or different than the first threshold. In an example, the second percentage threshold may comprise a second specified percentage. The percentage threshold is met when the first percentage threshold and/or the second percentage threshold are met. The duration threshold is met when the first duration and/or the second duration are met.

At 408, responsive to the stream of viewable percentages comprising the viewable percentage above the percentage threshold for the duration threshold a viewable impression beacon may be generated. The viewable impression beacon may be indicative of viewability of the advertisement. The viewable impression beacon may be sent to a database. The viewable impression beacon may comprise the viewable percentage and/or the duration that the advertisement is in view. A presence of the viewable impression beacon, associated with the advertisement, in the database is indicative that the advertisement was viewable by the user. An advertisement sale may be facilitated based upon the presence of the viewable impression beacon in the database. In an example, upon receipt of the viewable impression beacon, the advertiser, having placed the advertisement on the webpage, may be charged for the user's view. At 410, the method 400 ends.

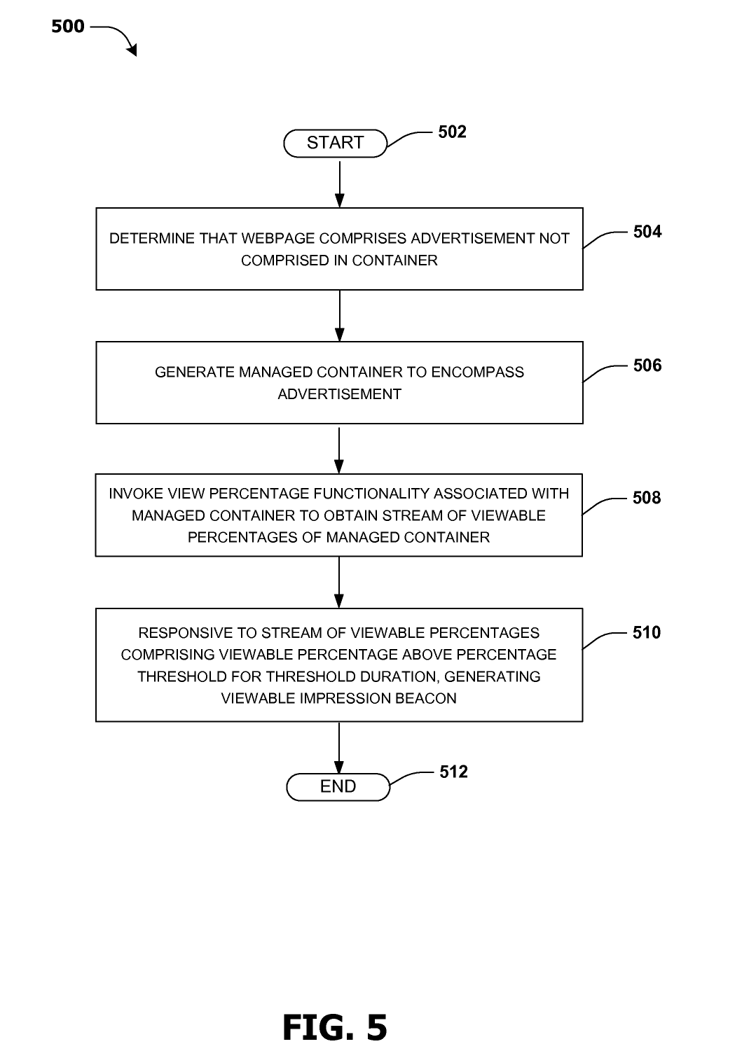

An embodiment for determining advertisement viewability is illustrated by method 500 of FIG. 5. At 502, the method 500 starts. A user may access a webpage comprising primary content (e.g., vacation photos of a vacation webpage). The webpage may comprise additional content, such as an advertisement (e.g., adjacent or near to the primary content). At 504, the webpage may be determined as comprising an advertisement that is not comprised in a container, for example, because the advertisement is not populated in an iframe.

At 506, a managed container may be generated to encompass the advertisement. The managed container may comprise implementing the iframe to contain the advertisement. The managed container may comprise a secondary domain implemented between the webpage and an external source from which the advertisement is populated. In an example, the managed container may isolate external content from the external source. In an example, the managed container may enable improved rendering of rich media in the iframe. While viewing the primary content a variable percentage of the advertisement may be viewable to the user.

At 508, a view percentage functionality associated with the managed container may be invoked to obtain a stream of view percentage of the managed container. In an example, the viewable percentage comprises a percentage of the managed container that is viewable to the user on the client device. In an example, the stream of viewable percentages comprises a series of determinations of the viewable percentage of the managed container to the user over a duration threshold. In an example, the stream of viewable percentages comprises a first stream portion and a second stream portion.

The view percentage functionality may be invoked to determine the viewable percentage of the managed container, by polling over a first duration at a first rate to obtain the first stream portion. In an example, the first rate may be between about 650 ms to about 850 ms or any other rate (e.g., a determination of the viewable percentage of the managed container may occur every 650 ms). In an example, the first duration may be between about 1 s to about 5 s or any other duration during which the first percentage threshold to be met. In an example, the first percentage threshold may comprise a first specified percentage.

Responsive to the viewable percentage of the managed container being over the first percentage threshold for the first duration, the polling is altered from the first rate to a second rate for a second duration to generate the second stream portion. The second rate may be faster than the first rate. In an example, the second rate may be between about 50 ms to about 150 ms or any other rate (e.g., the determination of the viewable percentage of the managed container may occur every 100 ms). In an example, the second duration may be between about 0.5 s to about 1.5 s or any other duration. In an example, a second percentage threshold may be the same or different than the first threshold. In an example, the second percentage threshold may comprise a second percentage threshold. The percentage threshold is met when the first percentage threshold and/or the second percentage threshold are met. The duration threshold is met when the first duration and/or the second duration are met.

At 510, responsive to the stream of viewable percentages comprising the viewable percentage above the percentage threshold for the duration threshold a viewable impression beacon may be generated. The viewable impression beacon may be indicative of viewability of the advertisement. The viewable impression beacon may be sent to a database. The viewable impression beacon may comprise the viewable percentage and/or the duration that the advertisement is in view. A presence of the viewable impression beacon, associated with the advertisement, in the database is indicative that the advertisement was viewable by the user. An advertisement sale may be facilitated based upon the presence of the viewable impression beacon in the database. In an example, upon receipt of the viewable impression beacon the advertiser, having placed the advertisement on the webpage, may be charged for the user's view, which was indicated by the viewable impression beacon. At 512, the method 500 ends.

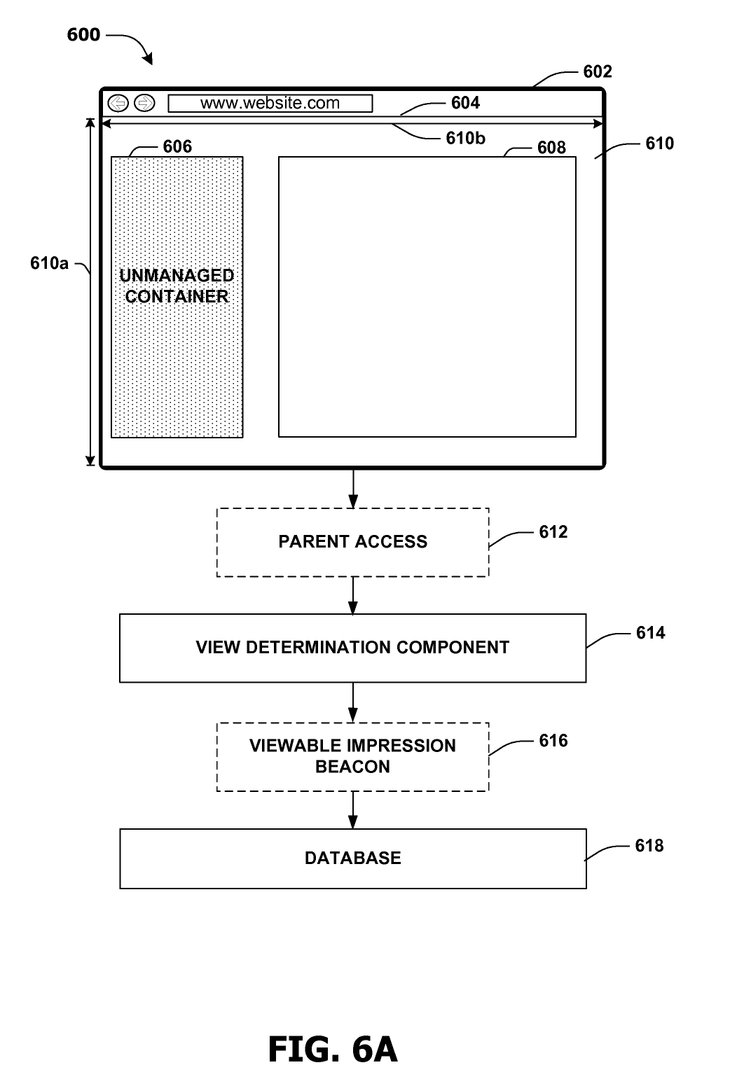

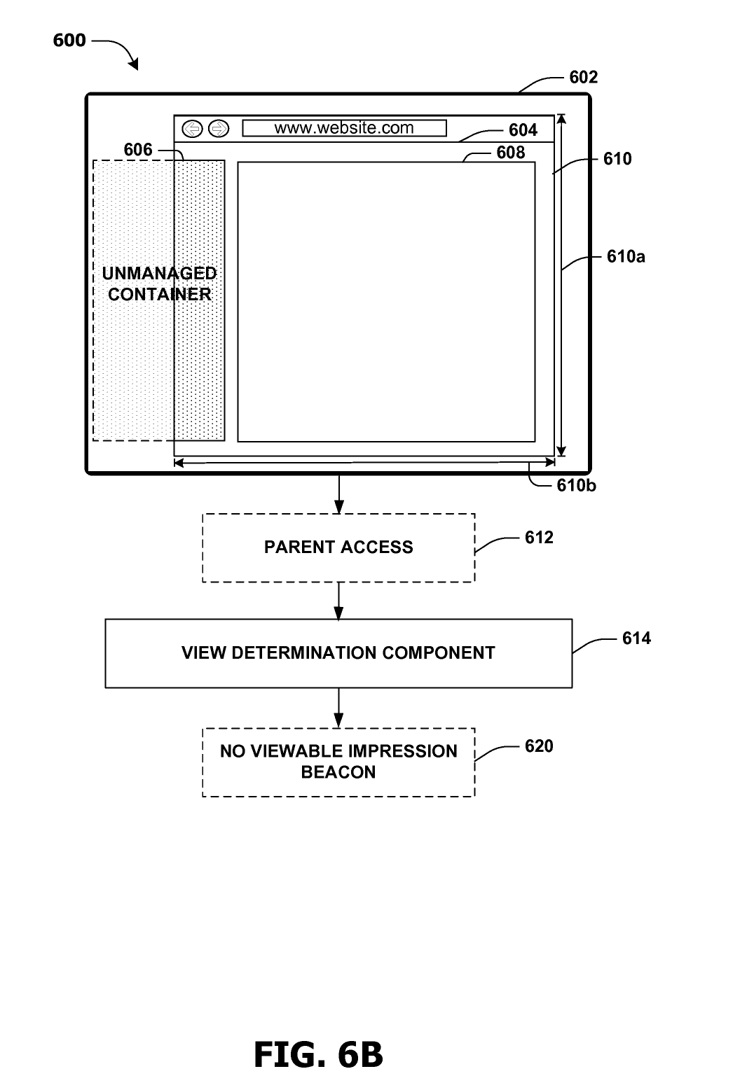

FIGS. 6A-6B illustrate a webpage 610 comprising an unmanaged container 606 wherein an advertisement may be populated. The webpage 610 may be displayed on a client device 602. The webpage 610 may include primary content 608 (e.g., adjacent or near to the advertisement). The webpage 610 may include an address bar 604. A view determination component 614 may be configured to determine a viewable percentage of the advertisement. The view determination component 614 may be configured to determine whether the advertisement is populated in a managed container, in the unmanaged container 606, or not within a container. For example, the advertisement may be determined to be comprised within the unmanaged container 606 (e.g., where the advertisement is populated in an iframe).

Responsive to the view determination component 614 determining that the webpage 610 comprises the unmanaged container 606, the view determination component 614 may be configured to determine whether parent access 612 to a document object mode (DOM) may be available. Responsive to determining that parent access 612 to the DOM is available, the DOM may be traversed to identify a container offset of the unmanaged container 606. The container offset may be determined by determining pixel coordinates of the unmanaged container 606 relative to the webpage 610. The pixel coordinates of the unmanaged container 606 may be determined by the DOM.

The container offset is compared to a total window size of the webpage 610 to determine a viewable area of the unmanaged container 606. The container offset may be determined by determining how much of the total window size of the webpage 610 comprises the unmanaged container 606. The container offset may comprise the viewable area of the unmanaged container 606. The total window size of the webpage 610 may be determined by determining a webpage height 610a of the webpage 610 and a webpage width 610b of the webpage 610. The total window size of the webpage 610 may not include the address bar 604. In an example, the webpage height 610a of the webpage 610 and the webpage width 610b of the webpage 610 may be determined using the pixel coordinates determined by the DOM. In an example, the total window size may be determined by multiplying the webpage height 610a of the webpage 610 with the webpage width 610b of the webpage 610. The viewable percentage of the unmanaged container 606 may be determined by comparing the viewable area of the unmanaged container 606 to a total area of the unmanaged container 606. The viewable percentage may be determined by dividing the viewable area of the unmanaged container 606 by the total area of the unmanaged container 606 and multiplying the total by one hundred.

Responsive to the viewable percentage being over a percentage threshold, a viewable impression beacon 616 may be sent to a database 618. The viewable impression beacon 616 may include the viewable percentage of the unmanaged container 606. In an example, the percentage threshold may comprise a specified percentage.

An advertisement sale may be facilitated based upon the viewable impression beacon 616, such as by charging an advertiser, who participated in the advertisement sale, based upon the viewable percentage of the unmanaged container 606 or based on a presence of the viewable percentage beacon 616 in the database 618.

Referring to FIG. 6A, the viewable percentage of the unmanaged container 606 is about one hundred percent. The webpage 610 may comprise a full screen view (e.g., the webpage 610 is displayed over the entirety of a display of the client device 602). Responsive to determining that the advertisement is populated in the unmanaged container 606, that parent access 612 is available, and that the viewable percentage is over the percentage threshold, the view determination component 614 may send the viewable impression beacon 616 to the database 618. The database 618 may comprise viewable percentages for one or more advertisements, which may be used to market advertisement sales. For example, a price may be assigned to a view of the advertisement, where the presence of the viewable impression beacon 616 may indicate one view of the advertisement.

FIG. 6B illustrates where the viewable percentage of the unmanaged container 606 is below the percentage threshold. The webpage 610 may comprise less than the full screen view (e.g., the webpage 610 is displayed over less than the entirety of the display of the client device 602). A portion of the unmanaged container 606 illustrated with dashed lines may illustrate the portion of the unmanaged container 606 that is not viewable to the user of the client device 602. Responsive to determining that the advertisement is populated in the unmanaged container 606, that parent access 612 is available, and that the viewable percentage is below the percentage threshold, the view determination component 614 may refrain 620 from sending the viewable impression beacon 616 to the database 618. The lack of the viewable impression beacon 616, associated with the unmanaged container 606, in the database 618 notifies a seller of the unmanaged container 606 that the advertisement was not sufficiently viewable to the user. In an example, the lack of the viewable impression beacon 616 in the database 618 may be used to determine a sale price for the advertisement populated in the unmanaged container 606.

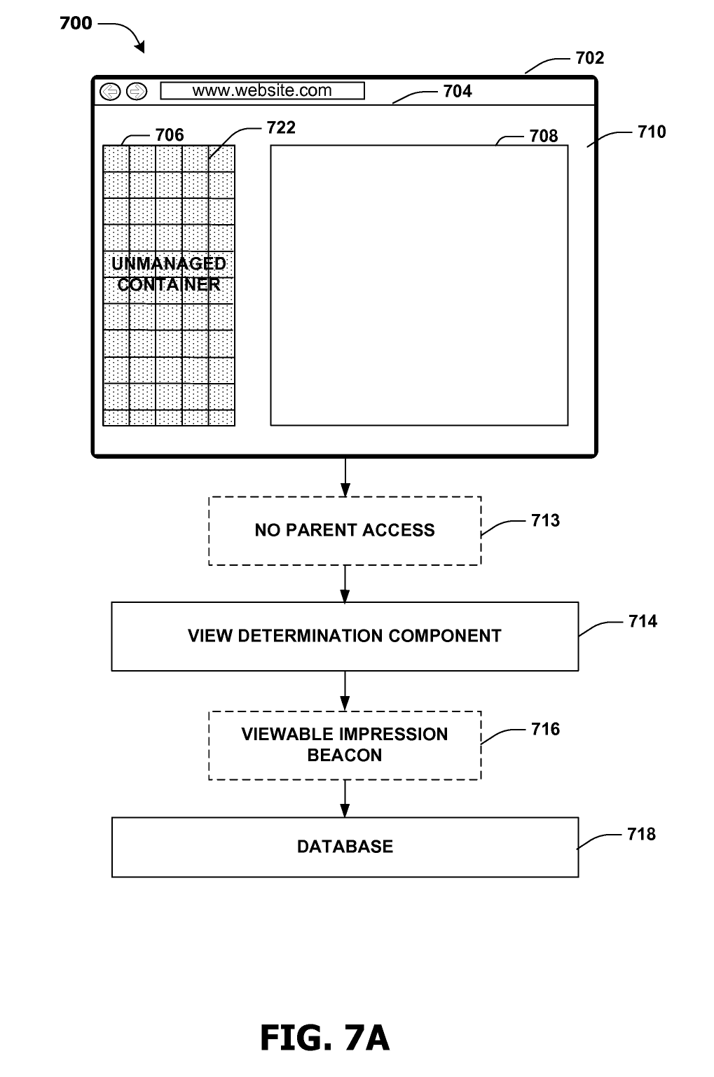

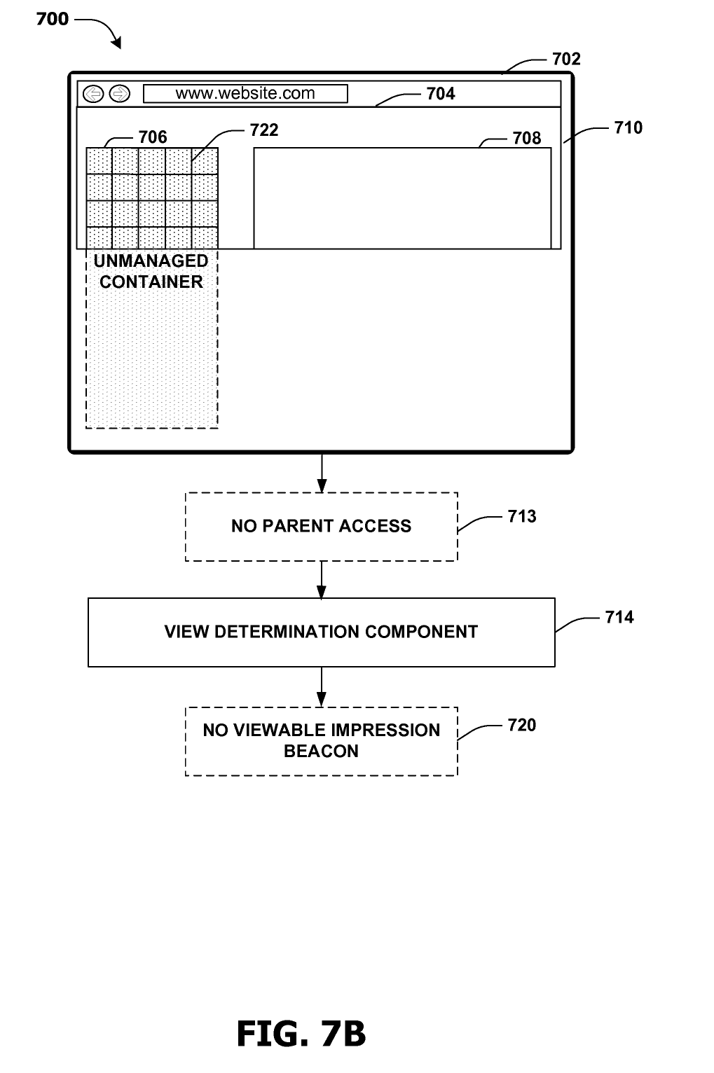

FIGS. 7A-7B illustrate a webpage 710 comprising an unmanaged container 706 wherein an advertisement may be populated. The webpage 710 may be displayed on a client device 702. The webpage 710 may include primary content 708 (e.g., adjacent or near to the unmanaged container 706). The webpage 710 may include an address bar 704. A view determination component 714 may be configured to determine a viewable percentage of the advertisement. The view determination component 714 may be configured to determine whether the advertisement is populated in a managed container, the unmanaged container 706, or not within a container. For example, the advertisement may be determined to be comprised within the unmanaged container 722 (e.g., where the advertisement is populated in an iframe).

Responsive to the view determination component 714 determining that the webpage 710 comprises the unmanaged container 706, the view determination component 714 may be configured to determine whether parent access to a document object mode (DOM) may be available. Responsive to determining that parent access to the DOM is not 713 available, a grid 722 may be generated by the view determination component 714 over the advertisement populated in the unmanaged container 706. The grid 722 may measure a number of browser animation plugins that are painted in the unmanaged container 706. In an example, a browser animation plugin is painted when pixels are drawn. The number of browser animation plugins that are painted may be determined by tracking a number of enterframes in the grid 722.

The view determination component 714 may compare the number of browser animation plugins that are painted in the grid 722 to a total number of browser animation plugins in the unmanaged container 706. The viewable percentage may be determined by dividing the number of browser animation plugins that are painted in the grid 722 by the total number of browser animation plugins in the unmanaged container 706 and multiplying the total by one hundred.

Responsive to the viewable percentage being over a percentage threshold, a viewable impression beacon 716 may be sent to a database 718. The viewable impression beacon 716 may include the viewable percentage. In an example, the percentage threshold may comprise a specified percentage. An advertisement sale may be facilitated based upon the viewable impression beacon 716, such as by charging an advertiser, who participated in the advertisement sale, based upon the viewable percentage of the unmanaged container 706.

Referring to FIG. 7A, the viewable percentage of the unmanaged container 706 is about one hundred percent. The webpage 710 may comprise a full screen view. Responsive to determining that the advertisement is populated in the unmanaged container 706, that parent access is not 713 available, and that the viewable percentage is over the percentage threshold, the view determination component 714 may send the viewable impression beacon 716 to the database 718. The database 718 may comprise viewable percentages for one or more advertisements that may be used to market advertisements sales. For example, a price may be assigned to a view of the advertisement, such that the presence of the viewable impression beacon 716 may indicate one view of the advertisement.

FIG. 7B illustrates where the viewable percentage of the unmanaged container 706 is below the percentage threshold. The webpage 710 may comprise less than the full screen view. A portion of the unmanaged container 706 illustrated with dashed lines may illustrate the portion of the unmanaged container 706 not viewable by the user of the client device 702. Responsive to determining that the advertisement is populated in the unmanaged container 706, that parent access is not 713 available, and that the viewable percentage is below the percentage threshold, the view determination component 714 may refrain 720 from sending the viewable impression beacon 716 to the database 718. The lack of the viewable impression beacon 716, associated with the unmanaged container 706, in the database 718 notifies a seller of the advertisement that the advertisement was not sufficiently viewable to the user. In an example, the lack of the viewable impression beacon 616 in the database 618 may be used to determine (e.g., lower) a sale price for the advertisement populated in the unmanaged container 706.

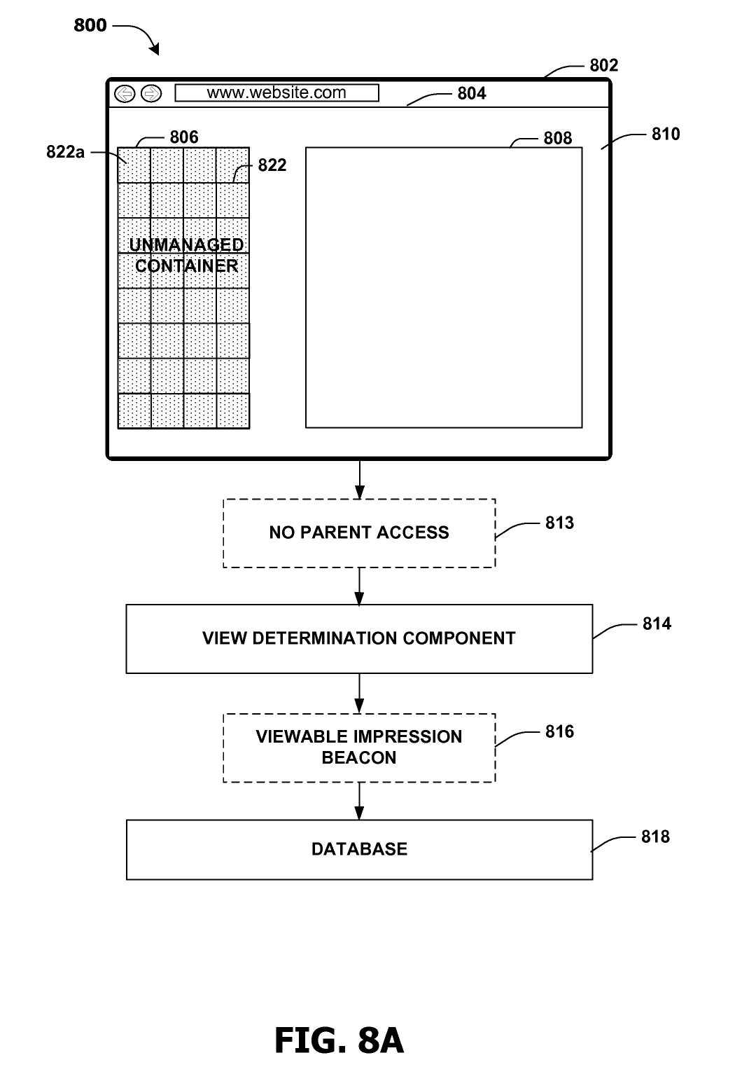

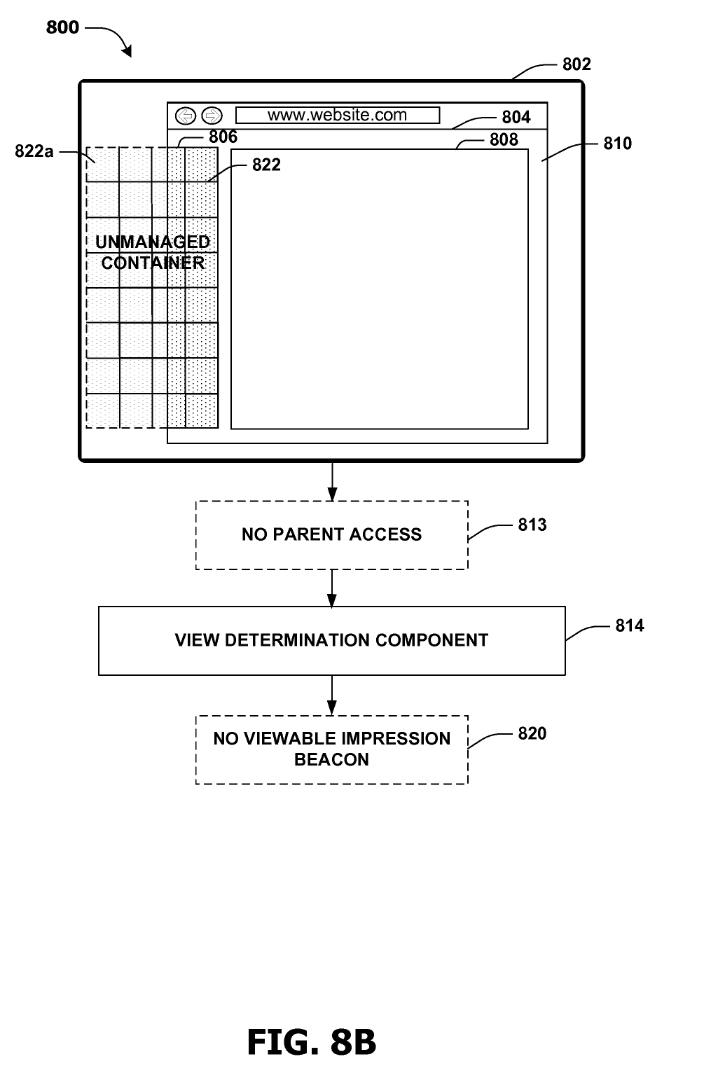

FIGS. 8A-8B illustrate a webpage 810 comprising an unmanaged container 806 wherein an advertisement may be populated. The webpage 810 may be displayed on a client device 802. The webpage 810 may include primary content 808 (e.g., adjacent or near to the advertisement). The webpage 810 may include an address bar 804. A view determination component 814 may be configured to determine a viewable percent of the advertisement. The view determination component 814 may be configured to determine whether the advertisement is populated in a managed container, the unmanaged container 806, or not within a container. For example, the advertisement may be determined to be comprised within the unmanaged container 806 (e.g., where the advertisement is populated in an iframe).

Responsive to the view determination component 814 determining that the webpage 810 comprises the unmanaged container 806, the view determination component 814 may be configured to determine whether parent access to a document object mode (DOM) may be available. Responsive to determining that parent access to the DOM is not 813 available, the view determination component 814 may be configured to determine whether an application program interface (API) configured to track a paint count may be available. Responsive to determining that the API is available, the view determination component 814 may be configured to create a grid of transparent containers 822 over the unmanaged container 806. In an example, the grid of transparent containers 822 comprises one or more transparent containers 822a. Paint count information from the grid of transparent containers 822 may be evaluated by the view determination component 814. In an example, the paint count information comprises a number of pixels that are drawn in the grid of transparent containers 822. The view determination component 814 may be configured to determine whether a transparent container in the grid of transparent containers 822 has been painted. The view determination component 814 may be configured to determine that the transparent container in the grid of transparent containers 822 has been painted where a number of pixels that are drawn in the grid of transparent containers 822 is increased.

The view determination component 814 may compare a number of painted containers in the grid of transparent containers 822 to a total number of transparent containers. The viewable percentage may be determined by dividing the number of painted containers in the grid of transparent containers 822 by the total number of transparent containers in the grid of transparent containers 822 and multiplying the total by one hundred.

Responsive to the viewable percentage being over a percentage threshold, a viewable impression beacon 816 may be sent to a database 818. The viewable impression beacon 816 may include the viewable percentage. In an example, the percentage threshold may comprise a specified percentage. An advertisement sale may be facilitated based upon the viewable impression beacon 816, such as by charging an advertiser, who participated in an advertisement sale, based upon the viewable percentage of the advertisement 806.

Referring to FIG. 8A, the viewable percentage of the unmanaged container 806 is about one hundred percent. The webpage 810 may comprise a full screen view. Responsive to determining that the advertisement is populated in the unmanaged container 806, that parent access is not 813 available, that the API is available, and that the viewable percentage is over the percentage threshold, the view determination component 814 may send the viewable impression beacon 816 to the database 818. The database 818 may comprise the viewable percentages for one or more advertisements that may be used to market advertisements sales.

FIG. 8B illustrates where the viewable percentage of the unmanaged container 806 is below the percentage threshold. The webpage 810 may comprise less than the full screen view. A portion of the unmanaged container 806 illustrated with dashed lines may illustrate the portion of the unmanaged container 806 not viewable to the user of the client device 802. The one or more transparent containers 822a over the portion of the unmanaged container 806 illustrated with dashed lines comprise transparent containers that are not painted. Responsive to determining that the advertisement is populated in the unmanaged container 806, that parent access is not 813 available, that the API is available, and that the viewable percentage is below the percentage threshold, the view determination component 814 may refrain 820 from sending the viewable impression beacon 816 to the database 818. The lack of the viewable impression beacon 816, associated with the advertisement 806, in the database 818 notifies a seller of the advertisement 806 that the advertisement was not sufficiently viewable to the user. In an example, the lack of the viewable impression beacon 816 in the database 818 may be used to determine a sale price for the advertisement populated in the unmanaged container 806.

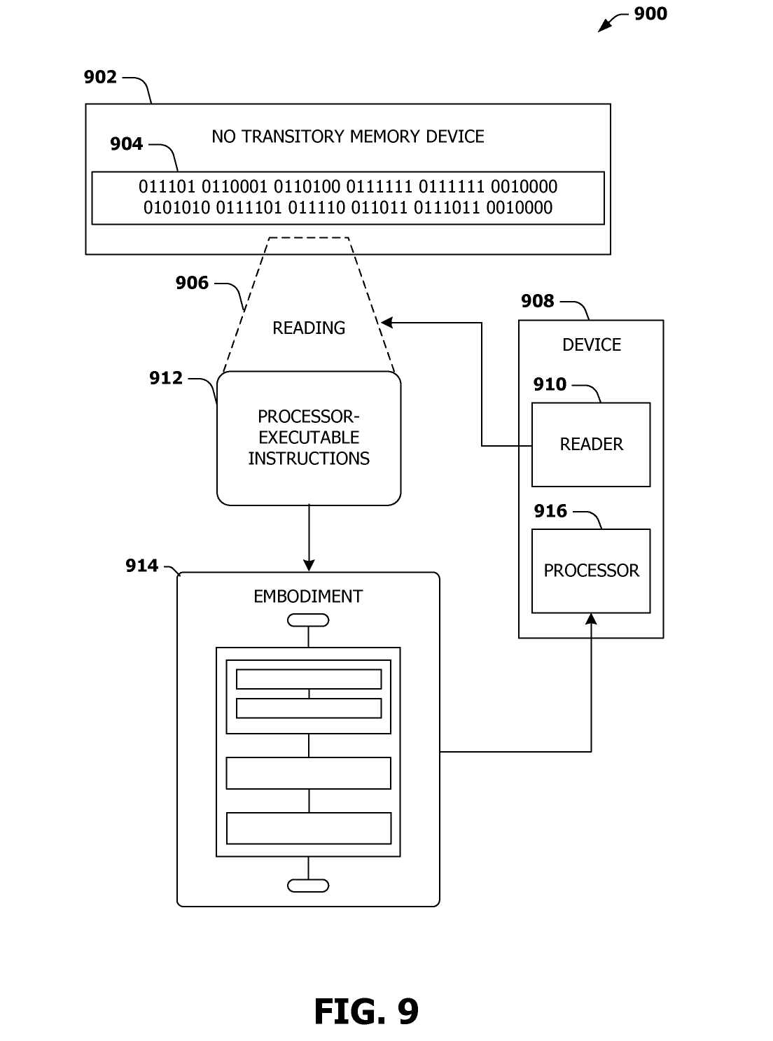

FIG. 9 is an illustration of a scenario 900 involving an example nontransitory memory device 902. The nontransitory memory device 902 may comprise instructions that when executed perform at least some of the provisions herein. The nontransitory memory device 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 902 stores computer-readable data 904 that, when subjected to reading 906 by a reader 910 of a device 908 (e.g., a read head of a hard disk drive, or a read operation invoked on a solid-state storage device), express processor-executable instructions 912. In some embodiments, the processor-executable instructions, when executed on a processor 916 of the device 908, are configured to perform a method, such as at least some of the example method 400 of FIG. 4, and/or the example method 500 of FIG. 5, for example. In some embodiments, the processor-executable instructions, when executed on the processor 916 of the device 908, are configured to implement a system, such as at least some of the example system 600 of FIGS. 6A-6B, at least some of the example system 700 of FIGS. 7A-7B, and/or at least some of the example system 800 of FIGS. 8A-8B for example.

### 3. USAGE OF TERMS

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for determining advertisement viewability, comprising:
determining that a webpage comprises a managed container within which an advertisement is populated;
invoking a view percentage functionality associated with the managed container to obtain a stream of viewable percentages of the managed container; and
responsive to the stream of viewable percentages comprising a viewable percentage above a percentage threshold for a duration threshold generating a viewable impression beacon for the managed container based upon the viewable percentage, the viewable impression beacon indicative of viewability of the advertisement.

2. The method of claim 1, the invoking comprising:
polling to determine the viewable percentage of the managed container in view over a first duration at a first rate to generate a first stream portion.

3. The method of claim 2, responsive to the viewable percentage of the managed container in view being over a second percentage threshold for the first duration:
altering the polling from the first rate to a second rate for a second duration to generate a second stream portion, where the first stream portion and the second stream portion comprise the stream of viewable percentages where the second rate is faster than the first rate.

4. The method of claim 1, comprising:
facilitating an advertisement sale based upon the viewable impression beacon.

5. The method of claim 1, the determining that a webpage comprises a managed container comprising:
determining that a secondary domain is implemented between the webpage and an external source from which the advertisement is populated.

6. The method of claim 1, comprising:
sending the viewable impression beacon comprising the viewable percentage to a database.

7. A system for determining advertisement viewability, comprising:
a view determination component configured to:
determine that a webpage comprises an unmanaged container within which an advertisement is populated; and
responsive to determining that parent access to a document object model (DOM) is available:
traverse the DOM to determine a container offset of the unmanaged container;
compare the container offset to a window size of the webpage to determine a viewable percentage; and
generate a viewable impression beacon for the unmanaged container based upon the viewable percentage.

8. The system of claim 7, the view determination component configured to:
determine that the webpage comprises the unmanaged container by determining the advertisement is populated in an iframe.

9. The system of claim 7, the view determination component configured to
determine the container offset by determining pixel coordinates of the unmanaged container viewable in the webpage.

10. The system of claim 7, the view determination component configured to:
responsive to determining that parent access to the DOM is not available:
generate a grid over the unmanaged container; and
detect a number of browser animation plugins that are painted in the grid.

11. The system of claim 10, the view determination component configured to:
detect the number of browser animation plugins by counting a number of enterframes in the grid.

12. The system of claim 10, the view determination component configured to:
determine a second viewable percentage of the unmanaged container by comparing the number of browser animation plugins that are painted in the unmanaged container to a total number of browser animation plugins in the unmanaged container.

13. The system of claim 12, the view determination component configured to:
generate the viewable impression beacon for the unmanaged container based upon the second viewable percentage.

14. The system of claim 7, the view determination component configured to:
responsive to determining that parent access to the DOM is not available and that an application program interface (API) configured to track a paint count is available:
create a grid of transparent containers;
evaluate paint count information for the grid of transparent containers;
determine a third viewable percentage based upon a number of painted containers in relation to a total number of transparent containers; and
generate the viewable impression beacon for the unmanaged container based upon the third viewable percentage.

15. The system of claim 14, the view determination component configured to:
responsive to the paint count information indicating that the paint count is increased in a first transparent container, determine that the first transparent container of the grid has been painted.

16. A non-transitory computer readable medium comprising computer executable instructions that when executed by a processor to perform for determining advertisement viewability, comprising:
determining that a webpage comprises an advertisement not comprised within a container;
generating a managed container to encompass the advertisement;
invoking a view percentage functionality associated with the managed container to obtain a stream of viewable percentages of the managed container; and
responsive to the stream of viewable percentages comprising a viewable percentage above a percentage threshold, generating a viewable impression beacon for the managed container based upon the viewable percentage, the viewable impression beacon indicative of viewability of the advertisement.

17. The method of claim 16, the invoking comprising:
polling to determine a viewable percentage of the managed container in view over a first duration at a first rate to generate a first stream portion.

18. The method of claim 17, responsive to the viewable percentage of the managed container in view being over a second percentage threshold for the first duration, altering the polling from the first rate to a second rate for a second duration, to generate a second stream portion, where the first stream portion and the second stream portion comprise the stream of viewable percentages, where the second rate is faster than the first rate.

19. The method of claim 16, comprising:
facilitating an advertisement sale based upon the viewable impression beacon.

20. The method of claim 16, comprising:
sending the viewable impression beacon comprising the viewable percentage to a database.
